(19) United States
(12) Patent Application Publication
(10) Pub. No.: US 2010/0135869 A1
(43) Pub. Date: Jun. 3, 2010

(54) OZONE GENERATORS

(75) Inventors: Lih-Ren Shiue, Hsinchu (TW); Masami Goto, Tokyo (JP)

Correspondence Address: The Law Office of Michael E. Kondoudis, 888 16th Street, NW, Suite 800, Washington, DC, 20006, US

(73) Assignee: LINXROSS, INC., Tokyo (JP)

(21) Appl. No.: 12/602,111

(22) PCT Filed: May 27, 2008
(86) PCT No.: PCT/JP2008/060117

§ 371 Date: Dec. 22, 2009

(30) Foreign Application Priority Data
May 28, 2007 (JP) 2007-164343

(51) Int. Cl. C01B 13/11; C02F 1/78

(52) U.S. Cl. 422/186.08

(57) ABSTRACT

An ozone generator for in-situ sterilization of water, which may be pocket-sized, is disclosed. The ozone generator includes a power source, at least a supercapacitor, a switching circuitry and at least a pair of electrodes. The power source is adapted for providing a reaction energy to generate ozone gas within the water to be treated. The supercapacitor is adapted for amplifying the reaction energy provided by the power source. The circuitry is adapted for controlling the supercapacitor to deliver consistent power supply to generate ozone. The electrodes are adapted for receiving the amplified reaction energy from the supercapacitor to generate ozone within the water to be treated.

### TECHNICAL FIELD

The present invention relates to the ozone generator for detoxifying and disinfecting water. More specifically, the invention relates to the ozone generator for the electrolysis of water forming ozone directly within the water by applying a DC power to an electrode pair in a simple construction

### BACKGROUND ART

Disinfection and detoxification of drinking water are very important to human health. Regardless of the water source, there must be some form of microorganisms including bacteria, viruses or protozoa present in water. Among them, pathogenic organisms, such as, diarrhea, typhoid, hepatitis and cholera, may result in death. The foregoing and other pathogens must be exterminated for safety. In addition, hazardous organic compounds, acids, bases, fertilizers, and pesticides discharged from factories and farms may get into the water reservoirs designated for public water supply. Many of the chemicals may cause cancers and they require detoxification before the water is consumed.

Water is the most likely source of sickness for people living in the areas with poor or lack of sanitation, such as, wild lands, mountains, lakes, and particularly places hit by natural disasters, for example, earthquake, hurricane, flood or tsunami. Protozoan parasites including Giaradia muris cysts, or Cryptosporidium oocysts, or both can be found in 97% of the surface water in the US. The former microorganism may cause chronicle beaver fever, while the latter may lead to serious cholera-like gastroenteritis in people who drink the infested water. On the other hand, pathogens like Escherichia Coli, Shigella and hepatitis A virus can easily be found in waters contaminated by animal fecal wastes and domestic wastewaters.

There are four primary methods of disinfection, that is, chlorination, chloramination, ozonation, and UV radiation. By far, chlorine is the most widely used disinfectant for killing the water-borne microorganisms in public water supplies around the world. In addition to the distinctive odor and the ineffectiveness of handling the protozoan, the chlorine treatment may generate carcinogens from the reaction of the chlorine with the organics present in the water. In December 2005, the US Environment Protection Agency (EPA) had issued a Purifier Protocol and Standard that prohibits “residues from the disinfectant used for sterilizing drinking water”. Under this guideline, ultraviolet (UV) and ozone (O₃) meet such standard as they are chemical-free disinfectants for purifying water. As a matter of fact, in Nice, France, ozone has been used to sterilize/disinfect the public water supply, since as early as 1906. Today, the UV irradiation process is included as one of the standard manufacturing processes in bottled-water and desalination plants. Ozone is listed as “Generally Recognized As Safe” (GRAS) for both potable and bottled water by the US Food and Drug Administration (FDA).

Electrolytic sterilization is a technique that uses an electric current to generate a disinfecting agent in water to serve as bactericide, virucide and or cyst inactivator. Among all chemicals, sodium chloride (NaCl) is the most popular precursor for making sodium hypochlorite (NaOCl) as the disinfectant as disclosed in the U.S. Pat. Nos. 3,622,479; 4,512,865 and 4,761,208. In the electrolytic detoxification, NaOCl is formed in electrochemical cells for removing ammonia (NH₃) from water as disclosed in U.S. Pat. Nos. 5,935,392 and 6,348,143. In all of the foregoing reactions, OCl⁻ ion is the oxidant adapted for sterilization or denitrification. Some of the ionic agents may survive the reactions and then become contaminants resulting in an increase of the TDS (Total Dissolved Solids) of the waters treated by OCl⁻. Many electrolytes specifically prepared to serve as the precursors for various agents formed electrolytically have been disclosed in numerous patents, for example, U.S. Pat. Nos. 5,531,883 and 5,997,702, just to name few. All in all, the chemicals added in the processes of electrolytic sterilization or electrolytic detoxification will become contaminants themselves, therefore leaving the treated water far from clean or safe.

Without adding any chemicals to the water to be treated, the sterilization of water is conducted through a direct electrolysis on sandwiched porous graphite electrodes as disclosed in U.S. Pat. No. 5,744,028, wherein the reaction current is too low to be effective. In U.S. Pat. No. 4,936,979, two alloy electrodes comprised of 88% copper (Cu), 10% tin (Sn) and 2% lead (Pb) are utilized electrolytic sterilization. The electrodes are consumed to provide 1 ppm (parts per million) Cu²⁺ for killing algae, as well as 0.5 ppt (parts per thousand) Sn²⁺ and 0.5 ppm Pb²⁺ for killing bacteria. The foregoing treatment may work for swimming pools, but it is incapable of eliminating the cyst contamination. Although ozone is a much more potent oxidant than OCl⁻, and applications of the gas are as versatile as from drinking-water sterilization, cleansing of semiconductor wafers as disclosed in U.S. Pat. No. 7,004,181, to medical treatments as disclosed in U.S. Pat. Nos. 5,834,030 and 6,902,670, nevertheless, the oxidizing gas is overwhelmingly generated by corona discharge. The silent discharge method has many problems, for example, a high working voltage, oxygen provision, gas leakage and ozone dissolution. Not only are the foregoing disadvantages absent from the electrolytic generation of ozone, but unique advantages are also present in the in-situ method as elaborated in U.S. Pat. No. 6,984,295. Without chemicals or electricity, ozone is produced via the absorption of 185 nm UV by oxygen as disclosed in U.S. Pat. No. 4,230,571. Recently, UV sterilizers have been fabricated into a hand-held device size for onsite sterilization of potable water. Compared to the aforementioned bulky electrolytic cells, the mini-size UV sterilizer is user-friendly, but the UV lamp is vulnerable to damage under external force.

### DISCLOSURE OF THE INVENTION

### Technical Problem

Accordingly, a first aspect of the present invention provides a robust, chemical-free and compact ozone generator capable of being battery operated suitable for sterilizing/disinfecting and detoxifying waters, e.g., potable waters.

### Technical Solution

The first aspect of the present invention is directed to an ozone generator that can be immersed in water for in-situ sterilization/disinfection of water and can be made pocket-sized.

In order to realize the object of the first aspect of the present invention, the ozone generator for in-situ sterilization of water, comprising:

a power source, for providing a reaction energy to generate ozone gas within water to be treated;

at least one supercapacitor, for amplifying the reaction energy provided by said power source;

a circuitry, for controlling said supercapacitor to deliver consistent power supply to generate ozone; and

at least a pair of electrodes, for receiving the amplified reaction energy from said supercapacitor for generating ozone within the water to be treated.

The following are preferable or specific embodiments of the first aspect of the present invention. Any combinations of (2) to (10) are preferable or specific embodiments unless any contradictory occurs.

(1) The power source is selected from a group consisting of primary batteries, secondary batteries, fuel cells and solar cells.

(2) The supercapacitor has an operating voltage of at least 2.5V, and at a capacitance of at least 0.5 F.

(3) The zone generator comprises at least two identical supercapacitors, and the control circuitry comprises a switching device which switches said at least two identical supercapacitors to be operated between charging and discharging states.

(4) The switching device comprises a relay or a MOS-FET (metal oxide semiconductor, field effect transistor).

(5) The switching frequency comprises 6 cycles per second or above.

(6) The electrodes have a shape of mesh, screen, or wire network.

(7) The electrodes comprises platinum or boron doped diamond.

(8) The power source is a human-powered generator, and the at least one supercapacitor comprises a supercapacitor in large capacitance to store the energy generated by the said human-powered generator and at least one supercapacitor in small capacitance, for amplifying the reaction energy provided by said power source;

(9) The human-powered generator is a generator that produces electricity through electromagnetic induction.

(10) The supercapacitor for energy storage has a capacitance of at least 6 F.

A second aspect of the present invention has been accomplished to realize an cost-effective and configurable ozone generator in connection with the first aspect of the present invention.

In order to accomplish the object of the second aspect of the present invention, the ozone generator comprises:

at least an anode containing a material with high oxygen evolution potential;

at least a metal cathode;

a constant gap between the said anode and said cathode;

a potential source;

at least one supercapacitor; and

an implementation of the said supercapacitor for power provision.

The following are preferable or specific embodiments of the second aspect of the present invention. Any combinations of the following are preferable or specific embodiments of the second aspect of the second invention, unless any contradiction occurs.

(1) The material is selected from a group of materials containing SnO₂, Sb—Ni doped SnO₂, Ti, and Pt.

(2) The material is SnO₂ or Sb—Ni doped SnO₂.

(3) The material is Sb—N doped SnO₂.

(4) The Sb—Ni doped SnO₂ is one produced from an Sb precursor, an Ni precursor and an SnO₂ precursor and a carbon source through sintering.

(5) The cathode is selected from a group of materials containing Pt, stainless steel, and nickel.

(6) The electrode gap is 0.5 mm to 5 mm

The above features of the second aspect of the present invention have been selectively determined through careful consideration of various matters in conjunction with the first aspect of the present invention. Finally, Sb—Ni-doped SnO₂ has been determined most preferable as the material with the high oxygen evolution potential, though other materials mentioned below are acceptable in connection with the first aspect of the present invention.

Due to its short lifetime (ca 30 minutes), ozone is unsuitable for storage or shipping. It is produced right before use and at the point of use. Ozone is best generated via the low-voltage electrolytic method. Due to its short lifetime (ca 30 minutes), ozone is unsuitable for storage or shipping. It is produced right before use and at the point of use. Ozone is best generated via the low-voltage electrolytic method. There are three major problems as mentioned below. present in the prior arts of electrolytic ozone including the U.S. Pat. Nos. 5,407,550 to 6,984,295.

That is, a first problem is the anode material that is utilized as the electrocatalyst for forming ozone in electrolyzing water. Platinum and β-PbO₂ are the two most widely used ozone-forming materials. However, Pt is prohibitively expensive and less efficient for the ozone formation at ambient temperature, though acceptable. On the other hand, the lead dioxide can produce ozone with a high efficiency at room temperature, but lead is an environmental hazard that is banned in many countries for water treatment.

A second problem for the electrolytic ozone is that an ion-exchange membrane is required for the generation of ozone. Not only the membrane is expensive, but also it severely restricts the scope of utilization of the electrolytic ozone systems containing the membrane. There are so many contaminants as can easily foul the membrane that the material can not be in direct with wastewaters. As a consequence, the electrolytic ozone is implemented in a similar way as the corona discharge wherein the ozone is formed at a separate location followed by the delivery of the gas into the water to be disinfected.

This constitutes a third problem of the electrolytic ozone for its incapability of performing in-situ and instantaneous disinfection. Therefore, an efficient and economic electrocatalyst for the generation of ozone, as well as a convenient and effective implementation of ozonation are urgently needed in connection with the first aspect of the present invention, which has been accomplished by the second aspect of the present invention.

Further, the second aspect of the present invention is to identify a long-term stable anode material containing no noble metal (e.g., Ru, Ir and Pd) for treating wastewater electrochemically in connection with the ozone generator according to the first aspect of the present invention. A bimetal doped tin dioxide (M-SnO₂, M=Sb and Ni) thick-film appears to best meet the goal as the electrocatalyst for generating ozone (O₃) directly within the waters to be detoxified or disinfected. Using an economical precursor of tin, stannic chloride, together with doping chemicals (Sb and Ni), the doped tin dioxide film can be stepwise grown on different sizes of titanium (Ti) substrates forming the anode electrodes in the desired dimensions and configurations to meet the application needs. Fabrication of the tin dioxide electrodes contains three steps including coating, pyrolysis, and sintering. Actually, a performing and reliable tin dioxide catalyst is built by stepwise epitaxy of nano-size tin dioxide particles into a monolithic structure on the Ti substrate. As the tin dioxide film is deposited layer by layer, the “coating and pyrolysis” steps must be repeated several times before the final sintering treatment. Collectively, the number of pretreatment cycles and the heating conditions determine the durability and performance of tin dioxide film resulted. While Ti metal serves as the film forming substrate and electric conductor for tin dioxide grown atop, the quickly formed surface oxide of Ti, that is, titanium dioxide (TiO₂), works as an adhesive bridge between tin dioxide film and Ti metal underneath, as well as a resistant barrier to protect the substrate from the harsh environment of ozone generation. Furthermore, the present inventors discovered that the Sb—Ni doped SnO₂ film is more advantageously produced from the precursor of tin, the doping chemicals (Sb and Ni) and a carbon source such as glycerol through coating, pyrolysis, and sintering. With the presence of glycerol, the resulting film is condensed and smooth without crack, exhibiting more excellent performance.

The second aspect of the present invention is to provide an implementation method of the Sb—Ni-doped SnO₂ film for the on-line and in-situ detoxification or disinfection of various wastewaters continuously. Please note that hereinafter, Sb—Ni doped SnO₂ is referred to as M-SnO₂, which includes both the Sb—Ni doped SnO₂ and the Sb—Ni doped SnO₂ with use of the carbon source. In conjunction with anode, the M-SnO₂-coated Ti plate, a metal plate such as a stainless steel plate is employed as cathode. Both electrodes have perforated holes or openings for water to flow through freely. An ozone reactor is constructed by arranging a plural number of anode-cathode pairs in a tandem stack, wherein plates are parallel to one another, using plastic screens, or holding frames for the provision of a constant gap among the electrodes to prevent electric short. Since the electrodes, spacers, and frames are resistant to virtually all chemicals and fine particles, the foregoing O₃ reactor can be installed directly in any wastewater to generate ozone therein for in-situ and instantaneous detoxification and disinfection. As the oxidant is improvised, there is no need of delivery and dispersion of O₃ gas into the water to be treated. Moreover, there is no air pollutant, for example, NOx, and the floor space of the said reactor is very minimal. The ozone bubbles formed by the said reactor are ultra fine. No disperser system can generate as fine and as uniform bubbles as the reactor using M-SnO₂ film. In addition to fast detoxification and disinfection, the fine bubbles facilitate the reaction of ozone with water to form hydrogen peroxide (H₂O₂), another potent disinfectant. With the synergism of the peroxide, the present invention offers the advanced oxidation process (AOP) to the fast decomposition of organic and inorganic compounds, as well as to the rapid sterilization of microorganisms.

The third aspect of the present invention is further to provide an economical and reliable power provision system for the electrolytic disinfection. Due to the enormous volumes of industrial wastewaters, the ozone reactor demands a large electrode area measured in m² to meet the throughput requirements of water treatment. For a high treatment capacity, such as, more than 100 CMD (m³/day), a DC current density of 50 mA/cm², or 500 A/m², is often needed for the O₃ reactor operated at 20 DC V or lower. The power demand of low DC voltage and high DC current is exactly in line with the discharging characteristics of supercapacitor, an energy-storage device that can store electric energy in hundreds farad (F) of capacitance. All of the energy stored in the supercapacitor can be discharged in a split second resulting in peak currents. Hence, the supercapacitor is the best suitable power amplifier for a potential source to deliver the power required for operating the O₃ reactor. If the supercapacitor delivers a large quantity of electricity in one discharge, it needs a long period of charging time to refill the lost energy. There is no power can be supplied to the ozone reactor until the capacitor is fully recharged. This means that the conventional application of supercapacitor can not meet the constant power needs of continuous treatments of industrial wastewaters. A technique entitled “charging and discharging swing” (CD Swing) can drive 2 sets of supercapcitors to deliver consistent power to the O₃ reactor for continuous detoxification and disinfection of wastewaters. Using supercapcitors and the CD Swing, the power supply for the treatments of industrial wastewaters via the O₃ reactor of the present invention may become highly cost-effective.

### ADVANTAGEOUS EFFECTS

The ozone generator provided by the first aspect of the present invention, which may be made pocket sized, can effectively perform in-situ sterilization of waters, and can easily be carried by the tourists traveling to places without adequate sanitation facilities, for example.

The second aspect of the present invention can offer a cost-effective technology of performing ozonation using economical electrocatalyst, simple cell design, and efficient power provision. Various ozone generators for various ozonation needs can be easily fabricated based the good scalability and conformability of the fabrication process of Sb—Ni-doped SnO₂ electrodes, for example.

### BRIEF DESCRIPTION OF THE DRAWINGS

The present invention is best understood by reference to the embodiments described in the subsequent sections accompanied with the following drawings.

FIG. 1 is a schematic diagram of a pocket-size ozone generator showing the major components according to an embodiment of the present invention.

FIG. 2 is a circuit diagram for performing the charging-discharging swing on two groups of supercapacitors using relays as switching mechanism according to an embodiment of the present invention.

FIG. 3 is a circuit diagram for performing charging-discharging swing on two groups of supercapacitors using MOSFETs as switching mechanism according to another embodiment of the present invention

FIG. 4 is a view of electrodes suitable for the ozone generator according to an embodiment of the present invention.

FIG. 5 is a generic diagram of a flow-through ozone reactor for the detoxification and disinfection of wastewaters.

FIG. 6 is a schematic diagram of a flow-through ozone generator attached to the outlet of a faucet for disinfecting the drinking water.

FIG. 7 is a schematic diagram of a submersible ozone generator that can be placed in the water to be disinfected.

FIG. 8 is a schematic diagram of a flow-through ozone generator integrated with a RO (reverse osmosis) water treatment system that contains 3 pretreatment columns and 1 RO membrane cartridge.

FIG. 9 is a schematic diagram of a pocket-size ozone generator for individual oral hygiene.

FIG. 10 a schematic diagram of the control circuitry for performing CD Swing to drive 2 sets of supercapacitors to deliver consistent electric powers for electrolytic disinfection.

### BEST MODES FOR CARRYING OUT THE INVENTION

Now, the first aspect of the present invention will be explained in more detail.

The ozone generator according to the first aspect of the present invention, which may be made pocket-sized, may be driven by DC power, and is capable of generating ozone from within water at any point of use. In order to prolong the service life of the ozone generator, a durable and foul-free electrode is used for generating ozone.

An alkaline battery or rechargeable battery may serve as the main power source for driving the ozone generator to perform electrolysis on water to generate ozone. To minimize the size of the ozone generator, only a few batteries are required. Since the batteries can only deliver a small current, a supercapacitor is adapted to supplement the power deficiency of the battery. In addition, the supercapacitor can also extend the use-time of battery through the “load leveling” effect. Furthermore, two identical groups of supercapacitors are arranged to discharge and re-charge alternatively through a charging-discharging swing, or CD swing approach, so that the power delivered to the electrolysis reaction can be continuous and consistent.

Among the electrode materials available for ozone generation, platinum (Pt) or conducting diamond film (boron-doped diamond, BDD) may be selected for the sake of safety and hygiene. The decay of the foregoing electrode materials does not generate hazardous ingredients into the treated potable water. A plastic screen is disposed between the anode and cathode, which are symmetrical in shape and identical in composition, of the ozone generator to prevent an electrical short. The two electrodes and the plastic screen are fastened together. The electrode is easy to clean and maintain, and can be easily replaced. The ozone generator can also be used as a stirrer during treatment to ensure that all of the water is sterilized or detoxified. No air is required to be injected into the water during the treatment process, ozone is formed due to ionization of the water.

The surface area of the electrodes, the discharge rate of the battery, the capacitance of the supercapacitor, as well as the conductivity of the water to be treated collectively determine the concentration of ozone produced. Generally, the amount of ozone generated is sufficient for sterilization/disinfection of the water but safe for the users to drink. The sterilization time usually ranges around 30-60 seconds, and can kill most of the microbes contained in the water. The ozone generator may be equipped with a switch that can be used to operate the ozone generator for any desired preset time.

The preferred embodiments of the pocket-size ozone generator of the first aspect of the present invention are presented as follows.

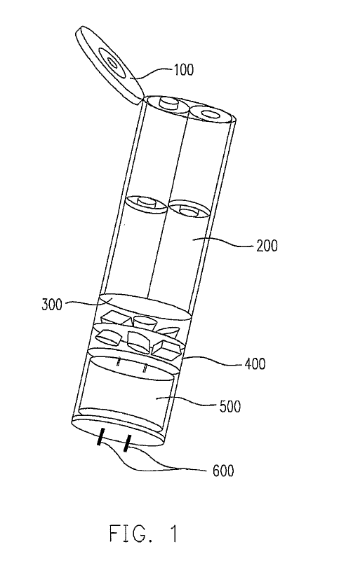

FIG. 1 shows the schematic configuration of. a hand-held pocket-size ozone generator that can perform in-situ sterilization or detoxification of waters at any point of use. As shown in FIG. 1, the generator comprises of a battery compartment with a lid 100, an IC board 400 and a pair of electrodes 600. The primary and the secondary batteries 200 inside the battery compartment are adapted for charging the supercapacitor and the IC board is adapted for controlling the charging of supercapacitor. Both of the primary battery and secondary battery serve as the main power source for providing power to the supercapacitors 500 which amplify the power to a sufficient level to rapidly produce ozone. The operating voltage and the discharge rate of the batteries 200 are important factors, which depend on the chemistry inside the battery 200. For an alkaline battery, the so called primary or non-rechargeable battery, every unit cell can deliver a working voltage of 1.5V at a rated capacity ranging from 1.1 to 17 Ah, depending on the battery size. Nevertheless, the practical Ah capacity is determined by the discharge rate of battery, that is, the discharge current. The rated Ah capacity is realizable when the battery is discharged at 25 mA or lower. Though a low discharge rate of an alkaline battery is disadvantageous for rapid sterilization, the battery is widely available and it can be put to use without the need of charging. On the other hand, the secondary or re-chargeable batteries can be discharged at a rate one fold higher than the alkaline battery. Their working voltage also varies greatly, for example, the nickel metal hydride (Ni-MH) is 1.2V and the lithium ion (Li+) battery is 3.6V. Using a higher voltage Li+ battery as the potential source allows for the pen-like O₃ generator to use 3-time less batteries compared to Ni-MH. However, all rechargeable batteries need a specific charger, and the batteries are limited in availability except in populated areas.

In order to produce a sufficient and safe amount of ozone, the maximum operating power for the ozone generator to perform in-situ and rapid sterilization of water is designed at 6 W. Considering the variation of water conductivity from miscellaneous water sources, the operating voltage of the ozone generator is set at 6V. Accordingly, the operating current should be 1 A to deliver the required 6 W power. The targeted current is beyond the allowable or optimal discharge rate of primary batteries and secondary batteries alike. Conventionally, a step-up circuit using DC/DC converter is used for producing high currents from low-current inputs of batteries. Such a converter is often bulky and costly, and therefore not suitable for the pocket size ozone generator shown in FIG. 1. A better approach is to employ a supercapacitor as a charge pump for the battery on the power provision for the ozone generation. Not only does the supercapacitor 500 store electrical energy just like the ordinary capacitors, but it also stores an amount of energy that is much more convertible to current outputs by many folds above that of the discharge currents of batteries 200. By simply connecting the battery 200 and the supercapacitor 500 in series or in parallel, the latter will be charged quickly to the voltage of the former. Thus, the supercapacitor 500 will deliver large currents for the battery 200 to meet the power demands, which results in a “load leveling effect”. Nevertheless, all capacitors are unable to continuously and consistently deliver power as batteries do for the energy content of capacitors is relatively low. Not only there is an idle period, or inconsistent power provision with using the capacitors, but there is also a significant waste of the stored energy of capacitors. Even though the wasted energy is ineffective to perform, it occupies a higher portion of the energy storage of capacitors than the effective energy. Henceforth, a control mechanism is needed to effectively utilize the supercapacitor's energy that is provided by batteries or other potential sources.

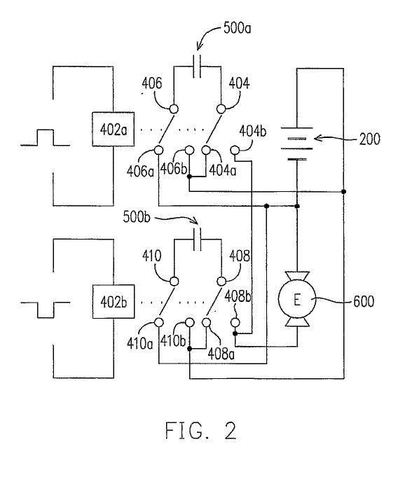

FIG. 2 shows a circuitry adapted for making the supercapacitors highly efficient to deliver consistent power. This circuit is depicted as 400 in FIG. 1. As shown in FIG. 2, the circuit is comprised of two supercapacitors 500a and 500b, each comprising two sets terminals 404 and 406, and 408 and 410, respectively. The supercapacitors 500a and 500b can be reciprocally switched between charging and discharging states, which is also known as CD swing, controlled by two relays 402a and 402b. Each relay is a double-pole double-throw (DPDT) mechanical switching device. At the initiation of CD swing, the two relays 402a and 402b are at the normally closed state as shown in FIG. 2, and two groups of supercapacitors 500a and 500b are charged in parallel by battery 200. The flow paths of the charging current in-and-out of the supercapacitors 500a and 500b are shown as follows:

Supercapacitor 500a: (+) pole of 200→404a→404→406→406a→(−) pole of 200

Supercapacitor 500b: (+) pole of 200→408a→408→410→410a→(−) pole of 200

Initially, the terminals of the supercapacitors 500a and 500b carry no polarity before charging. As the supercapacitors 500a and 500b are charged, their terminals will have the same polarity as that of the battery 200. That is, terminals 404 and 406 will serve as the positive and negative electrodes of the supercapacitor 500a, and the terminals 408 and 410 serve as the positive and negative electrodes of the supercapacitor 500b, respectively. The CD swing is initiated by depressing the latch button (not shown), an audible clicking sound is indicative of the switching of the relays 402a and 402b between “closed” and “open” states leading to the switching of the supercapacitors 500a and 500b between charging and discharging states. The operation procedure of the CD swing may be described as follows. The operation procedure of the CD swing includes at least a first cycle, a second cycle and a third cycle.

The First Cycle.

The relay 402a is switched “on” (“open” state) and the relay 402b remains at “closed” state (i.e. “off” state). Meanwhile, the relay 402a changes the contact points of two terminals 404 and 406 of the supercapacitor 500a from 406a/404a to 406b/404b. Thus, the (+) terminal 404 of the supercapacitor 500a is in electrical contact with the two electrodes 600, whereas the supercapacitor 500b remains in parallel with the battery 200. Since the supercapacitor 500b is charged, the battery 200 is prevented from charging the supercapacitor 500b. However, the supercapacitor 500b is also connected in series with the supercapacitor 500a (408→408a→406b→406), the supercapacitors 500a and 500b deliver at the combining voltages of the supercapacitors 500a and 500b, or two times voltage of 200, to the electrodes 600 through (+) pole 404 of the supercapacitor 500a. If the super capacitor 500b releases some of its stored energy, it will be promptly replenished by the battery 200 so that the supercapacitor 500b remains charged ready for assuming the role of discharge.

The Second Cycle.

The relay 402a is “off” (“closed” state) and the relay 402b is “on” (i.e. “open” state). The supercapacitor 500a is connected in parallel with the battery 200 for recharging the energy released in the prior discharging cycle. The contact points of terminals 408 and 410 of the supercapacitor 500b are switched from terminals 408a/410a to 408b/410b. Hence, the supercapacitor 500b will deliver an electric power to the electrodes 600 in conjunction with the supercapacitor 500a. Meanwhile, the supercapacitor 500a is replenished by the battery 200 via their parallel connection.

The Third Cycle and Beyond.

The third cycle includes flow of the first cycle and the second cycle being alternately repeated for every odd-cycle and every even-cycle of CD swing respectively to provide a consistent power supply to the electrodes 600 until the preset sterilization time period has reached (until latch button is turned off) to complete the sterilization.

In the CD swing technique as described above, two identical sets of supercapacitor are employed to reciprocally switch between charging and discharging for continuously supplying consistent power to the electrodes 600 to rapidly generate ozone that is several folds more effective than many other widely used disinfecting chemicals, such as chlorine, chlorine oxide or chloroamines. According to Jensen in “Ozone: The Alternative for Clean Dialysis Water” (DIALYSIS & TRANSPLANTATION, Volume 27, Number 11, pp 708-712, November 1998), the concentration-time value ranges (expressed as mg/L-min) for 99% inactivation of various organisms by O₃ at 5° C. is about 0.006-2.0 ppm-min. Thus, an operating voltage of 6V is sufficient to drive ozone generator of the present invention to generate the sufficient amount of O₃. For example, about 1 A of operating current and about 0.5 F capacitance for each of the supercapacitors 500a and 500b are required for the compact ozone generator to produce sufficient amount of ozone in about 30-60 seconds. Nevertheless, with the 5V driving-voltage threshold of the relays 402a and 402b, 4 pieces of alkaline batteries are required. Other power sources, for example, rechargeable batteries, fuel cells or solar cells, can also be used for driving the ozone generator of the present invention. Different power sources deliver different voltage outputs, and accordingly the design of the power compartment of the ozone generator should be varied. Regardless of the power source, the power can be amplified by the supercapacitors 500a and 500b and the relay-operated circuit. The relays 402a and 402b have a low-frequency, about 6 cycles per second (6 Hz), mechanically switching devices, and the low frequency will lead to a large fluctuation of output voltage for the power sources using the CD swing. Other disadvantages of the CD swing technique using a relay mat include mechanical wearing due to numerous times of switching, and a fusion of the relay contacts from an excessive current flow through the relay. However, since the ozone generator of the present invention consume significantly less power and has a low-switching operation, the relays can work well for rapid in-situ sterilization of potable waters.

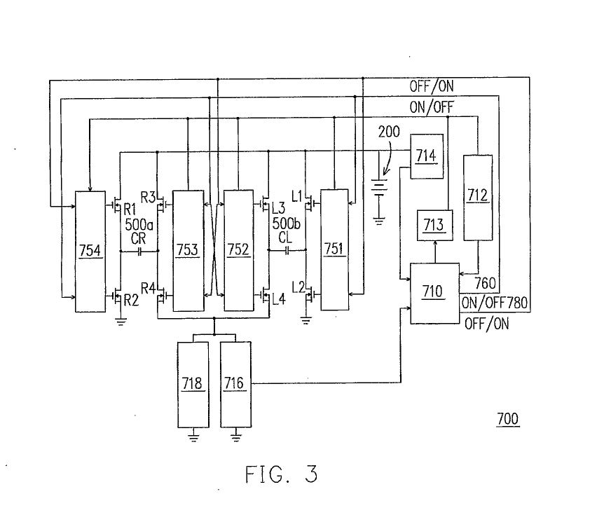

FIG. 3 shows the switching circuitry 700 for the CD swing technique using MOSFET (metal oxide semiconductor, field emission transistor) as the switching device according to a second preferred embodiment of the present invention. With fast response time and no moving parts, the MOS-FET can eliminate the low switching frequency and mechanical wearing problems of the relay. Nonetheless, the use of MOSFET is comparatively more complicated and expensive. Referring to FIG. 3, the power source for the pocket-size ozone generator includes a battery for supplying power to the two identical sets of supercapacitors 500a and 500b operating in the CD swing technique. The controller 710 will conduct the CD swing of the supercapacitors 500a and 500b, based on the feedback of voltage sensor 712, via two data buses 760 and 780. The latter will send the instructions of the controller 710 to the switching circuitries of MOS-FETs 751, 752, 753 and 754. The ON/OFF instructions transmitted via data buses 760 and 780 are opposite to each other at all times, that is, when the bus 760 is ON, the bus 780 is OFF, and vice versa. In order to provide a stable operating-voltage for the switching circuitries 751 to 754, their power supply is managed by a step up circuitry 713, a voltage stabilizer 714, and a bus 770. Each of the supercapacitors 500a and 500b has four (4) separate sets of MOS-FETs L1-L4 and MOS-FETs R1-R4, respectively. For the convenience of controlling FET by a positive pulse voltage, N-type FET is used to control the charging and discharging swing of the supercapacitors 500a and 500b. Contrarily, P-type FET is controlled by a negative pulse voltage that is inconveniently generated.

Before the initiation of charging-discharging process, the MOS-FETs L2 and L3 of the supercapacitor 500b are in the “closed” state, the MOS-FETs L1 and L4 of the supercapacitor 500a are in the “open” state, and the MOS-FETs R2 and R3 of the supercapacitor 500a are in the “closed” state and the MOS-FETs R1 and R4 are in the “open” state. Therefore, the supercapacitors 500a and 500b are connected in parallel with battery B, and the supercapacitors CL and CR are charged simultaneously to the same voltage and polarity of 200. Once the CD swing is initiated, the process will be conducted as follows:

The First Cycle

The supercapacitor 500a is in parallel with the battery 200, MOS-FETs L1 and L4 are in the “closed” state and MOS-FETs L2 and L3 of the supercapacitor 500b are in the “open” state. As a result, the supercapacitor 500b and the battery 200 are connected in series, thus, they discharge collectively to the load 718, or the electrodes of the ozone generator. The current delivered to load 718 is monitored by the current sensor 716 so that the power supplied to the ozone generator can be set at a desired level.

The Second Cycle.

The supercapacitor 500b is switched to the parallel configuration with the battery 200 (i.e. the MOS-FETs L2 and L3 are in the “closed” state, and the MOS-FETs L1 and L4 are in the “open” state), thus, the partially discharged supercapacitor 500b is replenished by the battery 200. Meanwhile, the supercapacitor 500a is switched into series connection with the battery 200 (i.e. MOS-FETs R1 and R4 are in the “closed” state, and MOS-FETs R2 and R3 are in the “open” state), thus, the supercapacitor 500a and the battery 200 discharge collectively to load 718 to generate ozone.

The Third Cycle and Beyond.

The third cycle, the first cycle and the second cycle, described above, that are repeated alternatively for every odd-cycle and every even-cycle furthering a CD swing technique, respectively, to provide a consistent power to the electrodes of the ozone generator of the present invention until the preset sterilization period has reached (i.e. until the latch button is depressed off) to complete the sterilization of the potable waters.

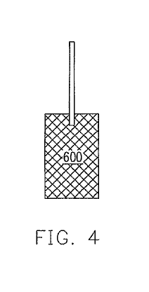

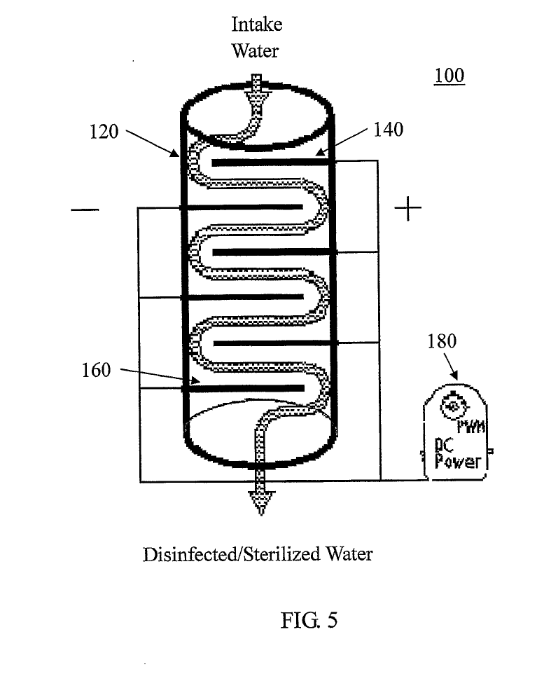

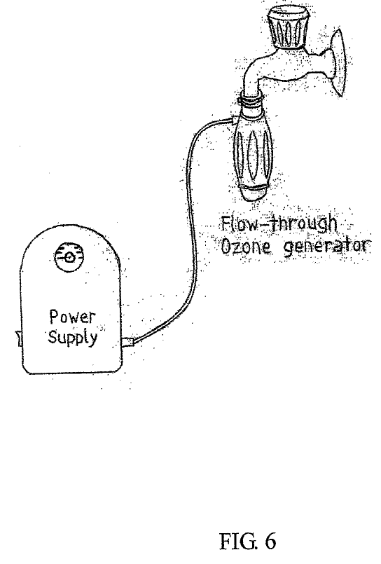

FIG. 4 shows a view of a structure of the electrodes 600 of the ozone generator according to an embodiment of the present invention. The electrodes are comprised of screen electrodes, each having a width of about 2.5 cm and a height of about 4 cm. A plastic 1 mm spacer (not shown) is interposed between the electrodes. The electrodes may be comprised of “platinum (Pt) or conductive highly boron-doped diamond (BDD) material coated titanium (Ti) meshes. A Ti rod of 2.4 mm diameter is welded to each screen electrode to electrically connect them to the power source. The electrodes and the plastic spacer may be fastened together by a plastic or an insulating strap into a replaceable electrode set. For a low cost and long-term use, no permeable membrane should be included in the electrodes of FIG. 4 for treating waters of high hardness. The high hardness is due to high amounts of magnesium and calcium ions present in the waters, and the ions are prone to form fine precipitates to clog the membrane. Nevertheless, when a proton-exchange membrane is disposed between the electrodes of FIG. 4, the ozone output is several orders higher than that yielded by the electrodes without the membrane. Henceforth, a proton-exchange membrane is integrated with the electrodes as FIG. 4 for the pen-like ozone generators intended for sterilizing tap water or other freshwaters with hardness no greater than 200 ppm.

Batteries with higher discharge rate than the alkaline batteries, for example, lithium ion battery, are employed with the electrodes as FIG. 4 to form ozone without the supercapacitors and the CD swing circuit. Ozone is also detected within a tap water treated by only the power of the batteries, however, the ozone generated is significantly lower than the output of the ozonators assisted by the supercapacitors. The pen-like ozone generator of the present invention has many selections on the power source. In addition to the batteries, human-powered generator and renewable energies can work as the potential source for the compact ozonators to perform the sterilization as well. A preferred embodiment is a detachable power source and a main O₃-generating body containing an electrode pair as FIG. 4 integrated with the CD swing circuit and built-in supercapacitors. Inside the main body, there are two kinds of supercapacitors, one has large capacitance, for example, 5V and 6 F or higher, to serve as an energy reservoir and the other is two groups of supercapacitors with 10-time lower capacitance, 0.6 F each, to discharge by the control of the CD swing circuit. Moreover, the main body has a power input socket for the electrical leads of the detachable power source to plug in. Renewable energy devices, such as, solar panels or micro wind turbines, can harness energy from the environments to charge the supercapacitor reservoir, which in turn delivers power to the smaller capacitors to discharge to generate ozone. Similarly, the human power is applied to a moving-coil resonant type liner generator to generate electricity through Faraday's law for charging the supercapacitor reservoir. The combinatory techniques of electromagnetic induction and supercapacitor for lighting, communication and entertainments are seen in U.S. Pat. Nos. 6,034,492, 6,217,398, 6,220,719 and 6,291,900. There is no similar application for the sterilization of waters yet. The mechanical motion required to generate electricity can be provided by hand shaking, hand or foot cranking. With the human-powered generator, the pocket-size ozone generator of the present invention may be used in areas where batteries are not affordable.

### EXAMPLES

### Example 1

A prototype ozone generator as shown in FIG. 1 may be manufactured using a pair of Pt-coated Ti mesh electrodes having the dimensions and configuration as depicted in FIG. 4. Four pieces of AA-size alkaline batteries are connected in series to form a 6V×2.78 Ah pack as the power source for providing electric energy to the two 5V×0.5 F supercapacitors. A switching circuit as shown in FIG. 2 is disposed between the batteries and the supercapacitors for managing the energy transfer between the two, as well as the charging and discharging swing of the supercapacitors. Once the CD swing is in operation, the power module composed of [batteries+switching circuit+supercapacitors] will output a voltage of about 11V DC. The aforementioned ozone generator was employed to perform in-situ sterilization on waters from two different sources, namely a faucet and a roadside ditch. Rather than the assessment of the inactivation of particular bacteria, the total quantity of bacteria killed in the waters was analyzed. The sterilization analysis was conducted by transferring 1 ml of untreated or treated water onto an aerobic count plate (Petrifilm™ from 3M, Saint Paul, Minn., USA), the bacteria count (expressed in cfu or colony forming unit per milliliter) after incubation at 36° C. for 68 hours was calculated. The test results are listed in Table 1.

TABLE 1
In-Situ Sterilization of Tap Water and Ditch
Water By a Pocket-Size Ozone Generator

| Water Samples | Tap Water | Ditch Water |
|---|---|---|
| Water Volume Treated (ml) | 200 | 200 |
| Sterilization Current (A) | 0.6 | 0.8 |
| Reaction Time (min) | 1 | 1 |
| Initial Bacteria Count (cfu/ml) | 600 | 840 |
| Post Bacteria Count (cfu/ml) | 2 | 5 |
| % of Bacteria Inactivated | 99.7 | 99.4 |

During the sterilization treatment, the water was stirred by the ozone generator. Water from roadside ditch was more contaminated than that from the faucet, therefore, the former consumed more energy to accomplish sterilization. In both cases, as can be inferred from the table above, the waters were effectively sterilized and disinfected.

Conclusion

As it can clearly be seen from the above example and other in-house tests, the compact pocket sized ozone generator provided by the present invention can effectively perform in-situ sterilization of waters, and can easily be carried by the tourists traveling to places without adequate sanitation facilities. A tune of 99% inactivation of microbial and hazardous contaminants present in the potable waters can be achieved in just 30-60 seconds of treatment. The hand-held pocket size ozone generator can be operated by batteries, human power and renewable energies, and it requires no addition of chemicals to the water to be treated. After treatment, the ozone will be converted to oxygen without forming any residues in the treated waters. The amount of ozone is sufficient for sterilization and at a level that is harmless to the users. Thus, no chemicals are required to generate ozone, and the ozone generator only requires the replacement of spent batteries, while the electrodes and human-powered generator may be used a long-period of time.

In the following, preferred and specific embodiments of the second aspect of the present invention will be explained in more detail.

As water becomes scarce, wastewater can become a valuable source for domestic and industrial use of water. In the households, only the potable water provided by the utility company is further purified, whereas the wastewater is simply discharged. Each household pays a fixed fee for the sewage treatment. It is a different situation in the industries for their wastewater discharged to a local wastewater treatment facility is charged according to the amount and types of pollutants released. If the industries can recycle their wastewater, the water retrieved may be used for production and the fee of wastewater treatment can be significantly reduced as well. There are four kinds of technology can be employed for turning wastewater into usable water: physical, chemical, biological, and membrane methods. Among them, chemical and biological treatments are highly effective in killing pollutants by oxidative decomposition, rather than retaining of pollutants which is normally happened in the physical and membrane treatments. Nevertheless, the chemical, particularly, the electrochemical oxidation consumes less energy, occupies smaller space, and generates fewer to none secondary pollution than that of biological oxidation. Electrolytic ozone is an electrochemical oxidation with a dual function that ozone is formed for in-situ ozonation, and many pollutants may be simultaneously oxidized by the anode. The key to the economical viability of electrolytic ozone is the anode material for producing the ozone gas. Only the material with high oxygen evolution potential is suitable for the operation. Several materials including β-PbO₂, boron doped diamond (BDD), glassy carbon, gold (Au), graphite, iridium oxide (IrO₂), palladium (Pd), and platinum (Pt), have been reported to have the activity on catalyzing the electrolysis of water to ozone. In the foregoing list, Pt and β-PbO₂ are two commonly electro-catalysts used to generate ozone from electrolyzing water. Due to high cost and low ozone-formation efficiency (0.5% at room temperature), Pt is less advantageous for industrial wastewater treatment. On the other hand, β-PbO₂ has higher current efficiency (13% at room temperature), nevertheless, the material is unstable and hazardous to the environment as the toxic lead ion (Pb²⁺) may leak into water.

A non-toxic semiconductor, tin dioxide (SnO₂), has been widely utilized in the production of sensors, batteries, electrochromic windows, solar cells, and liquid crystal display (LCD). As pointed out in R. Kötz, “Electrochemical Wastewater Treatment Using High Overvoltage Anodes. Part I: Physical and Electrochemical Properties of SnO₂ Anodes”, J. Appl. Electrochem., Vol. 21, No. 1, pp 14-20 (1971), pure SnO₂ is an n-type semiconductor with a direct band gap of about 3.5 eV. In addition, SnO₂ has other unique features: 1) high chemical and electrochemical stability, 2) high electronic conductivity when doped, and 3) high oxygen evolution overpotential. Particularly, the property advantageous to the electrolytic ozone is that the oxygen overpotential of SnO₂ is 0.6 V higher than that of Pt. From the cost perspective, SnO₂ is also more attractive than Pt. Although SnO₂ has been employed for the wastewater treatment as described in U.S. Pat. Nos. 5,364,509; 4,839,007 and 3,627,669, the material requires improvement and the rector or electrolyzer should be more effective. SnO₂ can be doped with metal, such as, antimony (Sb), or it can be doped with non-metal, such as, fluorine (F). For enhancing the efficiency of ozone generation, Wang Y-H and his group had doped SnO₂ with two kinds of metal in “Electrolytic Generation of Ozone on Antimony- and Nickel-Doped Tin Oxide Electrode”, J. Eelctrochem. Soc., Vol. 152, No. 11, pp D197-D200 (2005). The foregoing article is incorporated herein by reference for developing a proprietary fabrication process in the second aspect of the present invention (See Production process in “Experimental” and so on in Wang Y-H, etc, for example). Generally, the fabrication of Sb—Ni-doped SnO₂ electrodes is initiated by preparing an alcohol solution containing the precursors of Sn, Sb, and Ni in a specific atomic ratio, for example, Ni:Sb:Sn=1:10:600, for coating titanium (Ti) substrates. After the solution coated on Ti is converted to a layer of Sb—Ni-doped SnO₂ by pyrolysis under 100-300° C., the coating and pyrolysis cycle is repeated at least 10 times. Finally, the repeatedly coated Ti is sintered at 500-600° C. for 30 minutes to 2 hours. Both the number of coating-pyrolysis cycle and the conditions of heating treatment profoundly affect the ozone-forming capability and reliability of the Sb—Ni-doped SnO₂ electrodes fabricated. It is found that thicker coating by controlled heating yields electrodes with better quality. The stability of the dopants in the sintered oxide has been examined and validated by Cheng and his group using electrochemical and electron microscopic characterizations. The same group also measured the ozone generation current efficiency of over 30% at room temperature for the Sb—Ni-doped SnO₂ electrode. On the other hand, the present invention has identified the following characteristics of the Sb—Ni-doped SnO₂ electrode, which are beneficial to the effective use of electrolytic ozone for industrial wastewater treatments:
1. The fabrication process has good scalability on the fabrication of big sizes (even electrodes of 15″ diameter) and various forms of Sb—Ni-doped SnO₂ electrodes.
2. The wastewaters can be directly used as the media for the in-situ formation of ozone, rather than specific electrolytes, such as, sodium chloride or sulfuric acid.
3. Stainless steel can serve as the cathode for treating wastewaters containing low level chlorides, while titanium for waters of high chloride, for example, seawater.
4. No ion-exchange membrane is required for the separation of anode and cathode. The membrane is essential when Pt is used as the anode.
5. Ozone and oxygen bubbles formed on the Sb—Ni-doped SnO₂ electrodes are ultra fine. Coincident with the generation of ozone, hydrogen peroxide (H₂O₂) is formed by the reaction of mini ozone bubbles with water in a similar way as the natural occurrence of the peroxide in rain and snow.
6. Water flowing at high rates (10 liters/minute or higher) through the Sb—Ni-doped SnO₂ electrodes has no apparent effect on the potency of ozone.

In the preparation of metal-doped SnO₂ film with the carbon source on titanium substrates, the concentration of SnCl₄-5H₂O used can be from 0.5M to 3M, whereas the dopants SbCl₃ and NiCl₂-6H₂O can be from 2-20 mM and 1-2 mM, respectively. By keeping SnCl₄-5H₂O in the ethanol solution at the preferred concentration range of 1-2 M, the dopants SbCl₃ and NiCl₂-6H₂O can vary in the corresponding dosages of 4-16 mM and 1-2 mM, respectively, for forming ozone catalyst with good efficiency and good stability. Glycerol is also added at 0.5M to the ethanol solution containing the said three metal salts for facilitating the film formation through pyrolysis. With the presence of glycerol, the resulting film is condensed and smooth without crack. Titanium substrates of desired dimension and configuration are dipped in the precursor solution at desired concentrations for drying at 150-200° C. followed by 5-10 minute sintering at 500-6000° C. The dipping-drying-sintering cycle is repeated 10 times or more so that a metal-doped SnO₂ film at 20 μm or higher thickness may be attained. With a thick catalyst layer, the ozone anodes may be submerged directly in various types of wastewater for long-term service of disinfection. The aforementioned ozone anode can work with stainless steel or carbon-base cathode in wastewater to generate ozone therein. No specific electrolyte, such as perchloric acid, sulfuric acid or phosphoric acid, is needed for the said electrode pair to produce the disinfectant.

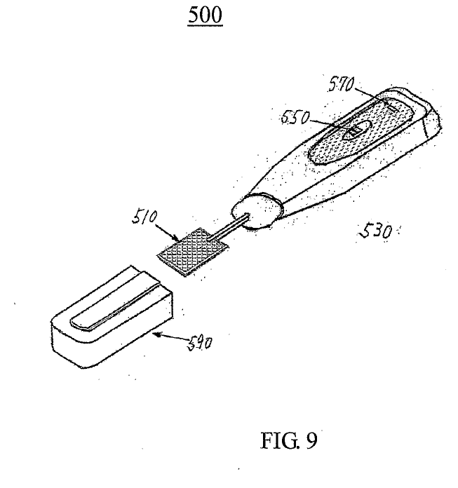

With the versatile electrodes made of materials with the high oxygen evolution potential, such as SnO₂, Sb—Ni-doped SnO₂, Sb—Ni-doped SnO₂ obtained with use of a carbon source, Ti and Pt, particularly the Sb—Ni doped SnO₂ or the Sb—Ni doped SnO₂ obtained with use of a carbon source, various ozone reactors can be designed accordingly for cost-effective treatment of various waters. FIG. 9 shows the schematic diagram of a generic flow-through ozone reactor 100, wherein 140 and 160 are monopolar anode stack and cathode stack, respectively, contained in the housing 120, and the electrodes are powered by the DC power supply 180 operated in pulse width modulation (PWM). The reactor 100 is a monopolar and undivided electrolyzer where all Sb—Ni-doped SnO₂ electrodes are connected in parallel to form the anode stack 140, and all stainless steel or titanium electrodes form the cathode stack 120. Every anode is faced by a parallel cathode, and vice versa. Either a non-conductive screen (not shown in FIG. 9) is placed between every pair of anode and cathode, or all electrode pairs are supported on a non-conductive frame (also not shown in FIG. 9) to produce a 0.5 to 5 mm electrode gap to prevent electrical shorts. Moreover, the electrodes can be either in mesh form, or they are equipped with perforated holes, so that the water to be treated can flow through the electrodes freely. Nevertheless, for the convenience of display, the water is shown to flow in a serpentine way through the ozone reactor in FIG. 9. Under the application of a DC voltage of 20 V or under from the power supply 180 to the electric terminals of anode stack 140 and cathode stack 160, the intake water may become completely disinfected or sterilized after one pass through the reactor 100. Scale-up of the reactor's treatment capability, or the ozone throughput, can be attained through the increase of electrode areas or the number of anode-cathode pairs. There is no limitation on the number of electrode pairs forming the ozone reactor, because the large currents associated with the large reactors can be provided by supercapacitors that will be elaborated in the later paragraph. In the applications of the ozone reactor 100, it can be a standalone unit as FIG. 9, or it can be formed by inserting just the electrode stacks in the conduits of water to provide online, in-situ, instantaneous, and continuous ozonation. Using electrodes of 15″ diameter or larger, together with the installation of multiple sets of the electrode stacks at various points of the industrial wastewater transfer system, the water can be treated to the desired purity at a flow rate of 10 liter/minute or higher. A power supply may provide the required power to multiple sets of online O₃ reactor, therefore, the ozone generators of the present invention take very minimal space in the industrial wastewater treatment facilities. Such on-line O₃ reactors can be applied not only to wastewater treatments, but also to the sterilization of public water supply so that the use of chlorine can be avoided.

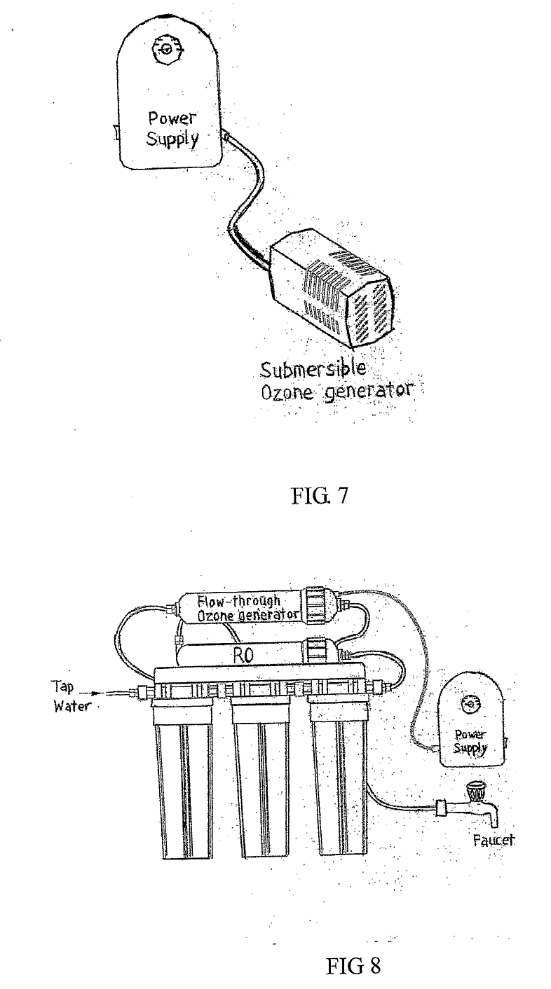

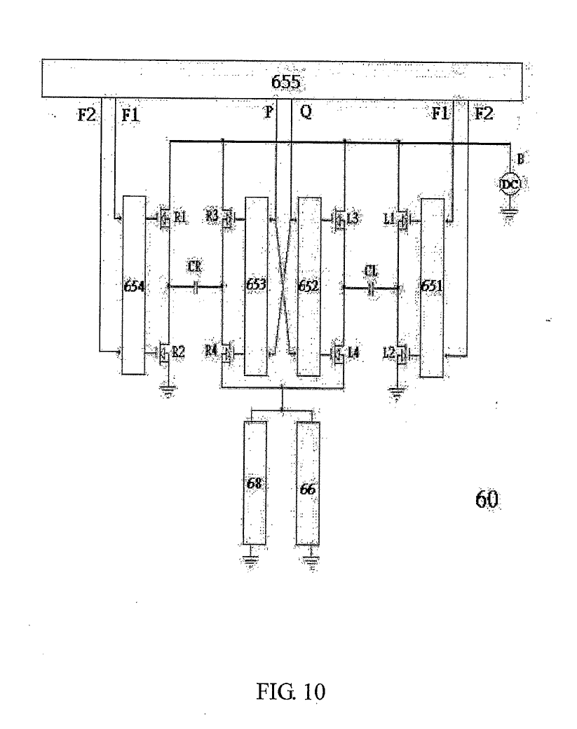

For households, offices, markets, and laboratories, there are three forms of flow though ozone generator can be devised to meet different ozonation needs. FIG. 10 shows the first preferred embodiment of the medium-size ozone generator, wherein the ozone-forming electrode stacks are confined in a flow-through housing that is attached to the outlet of a faucet. A sensor (not shown in FIG. 10) inside the housing will actuate the generation of ozone as the faucet is turned on and water is in contact with the sensor. The power level and duration for ozonation can be adjusted at an ozone throughput of no more than 1 ppm ozone in the water. With the presence of O₃, the sterilized water may be utilized for the cleansing of dishes, meats, fish, and lab-wares. FIG. 7 shows the second embodiment of medium-size O₃ generator by turning the electrode stacks and their housing into a submersible ozone generator. The submersible generators can be placed at any point of use, and the fine ozone gas will come out the openings of the housing for disinfecting fruits or vegetable placed in the water. Thirdly, FIG. 8 shows yet another embodiment of medium-size O₃ generator. As seen in FIG. 8, a standalone flow-through ozone generator is integrated with a regular RO (reverse osmosis) water-treatment setup that contains three stages of filtering cartridges as the pretreatment of incoming tap water for the RO. Because of no formation of poisonous gas (e.g., NOx), and controllable ozone generation (no risk of ozone leak) in the operation of electrolytic ozone, the medium-size ozone generators can be safely installed indoors. Comparing to FIG. 10, the generator of FIG. 8 can yield more ozone in water for storage, or for bottling of water in the beverage factories.

A portable ozone generator 500 for individual use is devised as shown in FIG. 9, wherein ozone-forming anode-cathode pair 510 with a plastic screen disposed in the middle of electrodes (not shown n FIG. 9) is secured and insulated at the tip of housing 530. Furthermore, the housing 530 has batteries inside, an on/off switch 550 and a LED (light emitting diode) indicator 570 on the top surface, as well as cap 590 for storing the electrode pair 510 when the generator 500 is not in use. The potable O₃ generator 500 can yield the disinfectant in water by a power supplied from a group of primary, secondary batteries, or renewable energy, such as, solar cells. Then, the ozone water can be used for personal hygiene care as mouth wash, or teeth cleaning agent to replace tooth paste. Also, due to the portability of O₃ generator 500, it is easy to travel with people to the areas where sanitized water is not available. Although specific embodiments and implementations of the electrolytic ozone generators are described herein for illustrative purposes, many relevant modifications can be made without departing from the spirit and scope of the present invention, as will be recognized by those skilled in the arts.

As voltage is required to overcome the electrical resistances of water, electrical connections, and electrode materials for driving power to the Sb—Ni-doped SnO₂ electrodes, the electrodes also demand currents of sufficient magnitudes for producing the desired dosage of ozone by electrolyzing the surrounding water. Without side reactions, such as, heat generation and electrode passivation or fouling, the higher the current provided, the more the ozone will be produced. Under a set operation voltage, the current required is proportional to the electrode area. Particularly, the operation current need for industrial ozone reactors, where the electrodes are often measured in m², will be tremendous. If the ozone generation is operated at the current density of 20 mA/cm², then every electrode surface area of 1 m² will need 200 A current. Such huge current demand is beyond the capacity of regular power grids, thus a heavy-duty power line must be ordered from the utility company with installation charge and high leasing fees. Furthermore, a power supply with complex circuitries for stabilizing and further stepping up the currents provided by the power line is needed for operating the industrial electrolytic ozone generators. The foregoing power supply is expensive to own and costly to maintain. Fortunately, the operation-power demand of the electrolytic ozone, i.e. low voltage and high current, is coincident with the electrical properties of supercapacitor, also known as ultracapacitor or electric double layer capacitor (EDLC). The capacitor is a passive energy-storage device with fast charge and discharge rates. The device is also an energy buffer and a power amplifier that can multiply the input power of charging sources to more than 10 times. It is the power amplifying capability and easy implementation that makes supercapacitor ideal for the job of power provisions to the electrolytic ozone for treating miscellaneous industrial wastewaters. Although the capacitor also has other merits, such as, long lifetime and maintenance free, it has some drawbacks as well. From the application perspective, the pulse delivery of power of supercapacitor, that is, the capacitor can only provide power in a pulse mode, appears incompatible with the need of continuous operation in the industrial wastewater treatments. Also, not all energy delivered by supercapacitor is effective. When the voltage of the capacitor has decayed to below the operation voltage of the electrolytic ozone, the discharge power becomes ineffective.

For consistent power delivery and high efficiency of energy use for the operation of electrolytic ozone, the present invention proposes a technique entitled “charging and discharging swing (CD Swing)” as the method of power provision. Two identical sets of supercapacitors and a charging source are needed to conduct the CD Swing. Each set of supercapacitors is allowed to discharge only the effective energy stored in the capacitors. As soon as the first set has delivered its effective energy, the second set will immediately assume the discharging role, and at the mean time the first set will undergo refilling the lost energy. In the next run, the two sets of supercapacitors will switch the positions of charging and discharging, and the reciprocal switching will continue until the operation is terminated. During the CD Swing operation, there is always one set of supercapacitors in series with the charging source for discharging, and the other set is in parallel with the charging source for recharging. Therefore, the output voltage is the sum of the voltages of supercapacitor set and charging source, which equals to the operation voltage of load. In other words, the CD Swing will reduce the use of supercapacitors or charging source to the amount sufficient for providing a voltage that is half of the driving voltage of load. FIG. 10 shows a preferred embodiment of switching circuitry 60 for executing the CD swing using MOS-FET (metal oxide semiconductor-field emission transistor) as the switching device. With fast response time and no moving parts, the MOS-FET can present a better reliability than that of relay. In FIG. 10, B is the DC charging source to provide energy to two identical sets of supercapacitor CL and CR for engaging the CD swing. Each of the supercapacitor modules CL and CR has 4 individual sets of MOS-FET, L1-L4 and R1-R4, respectively, for charging and discharging swing. Four switch-controlling circuitries designated by blocks 651 to 654 are used to control the on/off states of the eight MOS-FETs. The microcontroller 655 can monitor the voltage needs of loads 66 and 68, and it can also step up and stabilize the charging voltages for CL and CR, as well the CD swing of CL and CR via power bus F1, F2, P and Q. The on/off signals transmitted through the power bus are opposite to each other at all times, that is, when F1 and P are on, F2 and Q must be off, and vice versa. In order to provide a stable operating-voltage for the switching circuitries 651 to 654, their power provisions are managed by the microcontroller 655 and power bus connected to the potential source B. For the convenience of controlling the FET switches by a positive pulse voltage, N-type FET is used to control the CD Swing of CL and CR in FIG. 10.

Before the actuation of CD Swing, L2 and L3 are “closed” for CL (L1 and L4 are “open”) whereas R2 and R3 are “closed” for CR (R1 and R4 are “open”). Therefore, CL and LR are in parallel with the charging source B, and the capacitors are charged simultaneously to the same voltage and polarity of B. When the CD swing operation is in progress, the process will proceed as follows:

### 1. The First Cycle

While CR remains in parallel with B, L1 and L4 will be “closed” and L2 and L3 will be “open” for CL. As a result, CL and B are connected in series, henceforth, they discharge collectively to the load 68, or electrodes of the ozone generator. The current delivered to load 68 is monitored by the microcontroller 655 so that the power supplied to the generator can be set at a desired level for producing adequate dose of ozone.

### 2. The Second Cycle

CL is switched to the parallel configuration with the charging source B (L2 and L3 are “closed”, and L1 and L4 are “open”), thus, the partially discharged CL is recharged by B. Meanwhile, CR is switched into series connection with B (R1 and R4 are “closed”, and R2 and R3 are “open”), henceforth, CR and B discharge collectively to load 68 to generate ozone.

### 3. The Third Cycle and Beyond

The procedures of the first cycle and the second cycle are repeated alternatively for every odd-cycle and every even-cycle of further CD swing, respectively, to provide a consistent power to the electrodes of ozone generator until the treatment of water is completed.

With the power amplification of supercapacitors and the operation of CD Swing, various power levels can be provided for ozonation of various waters as described in Table 1:

TABLE 2
Power Levels for Different Ozonation Needs

| | | | |
|---|---|---|---|
| | Power | Depicted | |
| # | Levels | Figures | Applications |

| | | | | |
|---|---|---|---|---|
| 1 | >1 | kW | 1 | Industrial wastewater, |
| | | | | public water supply, |
| | | | | swimming pools, food, |
| | | | | beverage and |
| | | | | pharmaceutical plants |
| 2 | 150-500 | W | 2-4 | Households, offices, |
| | | | | markets, laboratories |
| 3 | 15 | W | 5 | Personal oral hygiene, cut |
| | | | | therapy |

In the following Examples, Sb—Ni-doped Sn O2 films, which had been produced on Ti plates by using glycerol, were used for electrodes.

### Example 2

A flow-through ozone reactors consisting of 4 pieces of Sb—Ni-doped SnO₂ electrodes of 2″ diameter and 4 pieces of 2″-diameter stainless electrodes of 2″ diameter and 4 pieces of 2″-diameter stainless steel plates is constructed as FIG. 9, wherein 0.5 liter of water can fill the housing. The reactor is used for discoloration of 3 mg methylrosaniline chloride dispersed in 1 liter of tap water, and the solution is pumped with a circulation flow rate of 2.5 liter/minute through the reactor. Under 10 DC volt applied to the electrical terminals of anode and cathode stacks from a power supply, the blue dye is faded to colorless in 3 minutes. A current of 2 A is registered during the ozonation.

### Example 3

An ozone generator as FIG. 9 is prepared using a pair of Sb—Ni-doped SnO₂ electrodes and 4 pieces of stainless steel electrodes in a rectangular configuration of 2 cm×4 cm. Four pieces of AA-size alkaline batteries are connected in series to form a 6V×2.78 Ah pack as the potential source of the generator for providing electric energy to two sets of 5V×0.5 F supercapacitor. A switching circuit as shown in FIG. 10 is disposed between the batteries and supercapacitors for managing the energy transfer between the two different devices, as well as the charging and discharging swing of supercapacitors. Once the CD swing is in operation, the power module composed of [batteries+switching circuit+supercapacitors] will output a voltage near 11V DC. The aforementioned O₃ generator is employed to perform in-situ sterilization on waters from two sources, faucet and roadside ditch. Rather than the assessment of inactivation of particular bacteria, the total quantity of bacteria killed for the waters is analyzed. The sterilization analysis is conducted by transferring 1 ml of untreated or treated water onto an aerobic count plate (Petrifilm™ from 3M, Saint Paul, Minn., USA), the bacteria count (expressed in cfu or colony forming unit per milliliter) after 36° C. and 68 hours incubation is calculated. The test results are listed in Table 2.

TABLE 3
In-Situ Sterilization of Tap Water and Ditch
Water By a Portable Ozone Generator

| Water Samples | Tap Water | Ditch Water |
|---|---|---|
| Water Volume Treated (ml) | 200 | 200 |
| Sterilization Current (A) | 0.7 | 1.0 |
| Reaction Time (min) | 0.5 | 0.5 |
| Initial Bacteria Count (cfu/ml) | 500 | 1200 |
| Post Bacteria Count (cfu/ml) | 1 | 5 |
| % of Bacteria Inactivated | 99.9 | 99.6 |

As seen in Table 3 the waters are quantitatively disinfected in both cases.

### Example 4

1.5 liters of 1% ammonia (NH₃) water is prepared for ozonation using an ozone reactor as Example 1. Another new 1% NH₃ solution is made for ozonation by similar reactor containing the same number pairs and dimensions of electrodes except using platinum coated titanium anode and titanium cathode. The two solutions of ammonia water are independently circulated through either ozone reactor at 2.5 l/min flow and 10 V DC applied to the electrical terminates of either reactor. Only the TDS of the ammonia water during ozonation is measured. Since the ozonation is began, the TDS of solution levels off at 600 ppm after 1 hour and 6 hours ozonation in the SnO₂ reactor and Pt-coated Ti reactor, respectively, indicating that the decomposition of ammonia by ozone has been completed in both reactors. Apparently, the SnO₂ reactor offers a quicker detoxification than that of Pt-coated Ti reactor. It is also observed that the zone bubbles of the former are finer and more abundant than the latter. Even the Pt-coated Ti reactor presents a stronger smell of O₃ odor than the SnO₂ reactor, the latter offers a faster killing of contaminants in water. The faster decomposition rate is likely due to the formation of hydrogen peroxide (H₂O₂) by the reaction between ozone and water, and the possible presence of advanced oxidation process (AOP) from the reaction of ozone and hydrogen peroxide, wherein hydroxyl radical is formed to expedite the decomposition.

Conclusion

Ozone is a powerful and environment friendly disinfectant for water treatment as the gas becomes oxygen after the reaction without leaving any hazardous residue from the agent behind. Due to the cost, space occupation, complexity of system, and potential air pollution, the ozonation using the corona discharge is not affordable to people who has the need ozone treatment. The present invention offers a cost-effective technology of performing ozonation using economical electrocatalyst, simple cell design, and efficient power provision. Various ozone generators for various ozonation needs can be easily fabricated based the good scalability and conformability of the fabrication process of Sb—Ni-doped SnO₂ electrodes, for example.

1. A ozone generator for in-situ sterilization of water, comprising:
a power source, for providing a reaction energy;
at least two identical supercapacitors, for amplifying the reaction energy provided by said power source through charging and discharging swing (CD swing) of said at least two supercapacitors;
a circuitry, for controlling said at least two supercapacitors to be operated in the CD swing to deliver a consistent power supply of the amplified reaction energy to generate ozone; and
at least a pair of electrodes consisting of an anode and a cathode with a constant gap kept therebetween, for receiving the consistent power supply of the amplified reaction energy from said at least two supercapacitors for generating ozone within the water to be treated,
said anode comprising Sb—Nrdoped SnO2₅ said Sb—Ni-doped SnO2 being a material obtained from an Sb precursor, an Ni precursor, an SnOz precursor and a carbon source through wet coating, pyrolysis, and sintering.

2. The ozone generator as claimed in claim 1, wherein said at least two supercapacitors have an operating voltage of at least 2.5V and a capacitance of at least 0.5 E

3. The ozone generator as claimed in claim 1, wherein the said cathode comprises stainless steel.

4. The ozone generator as claimed in claim 1, wherein the anode comprises a titanium (Ti) metal as a substrate.

5. The ozone generator as claimed in claim 1, wherein the said electrode gap may be 0.5 mm to 5 mm,

6. The ozone generator as claimed in claim 1, wherein the circuitry comprises a switching device which switches said at least two identical supercapacitors to be operated between charging and discharging states, and the switching device comprises a relay or a MOS-FET (metal oxide semiconductor, field effect transistor),

7. The ozone generator as claimed in claim 1, wherein the switching frequency comprises 6 cycles per second or above.

8. The ozone generator as claimed in claim 1, wherein the power source is selected from a group consisting of a primary battery, a secondary battery, a fuel cell, a solar cell, and a human-powered generator with a super capacitor to store the reaction energy generated thereby.

9. The ozone generator as claimed in claim 8, wherein the supercapacitor of the human-powered generator for the reaction energy storage has a capacitance of at least 6 F.

10. The ozone generator as claimed in claim 1, wherein the electrodes have a shape of mesh, screen, or wire network to be placed directly in the water to be treated and to allow the water to pass therethrough.
